(19) United States
(12) Patent Application Publication
(10) Pub. No.: US 2016/0206947 A1
(43) Pub. Date: Jul. 21, 2016

(54) LIGHT-EMITTING SOLE AND LIGHT-EMITTING SKATE

(71) Applicant: Juei-Chieh Yu, Dongguan (CN)

(72) Inventor: Juei-Chieh Yu, Dongguan (CN)

(21) Appl. No.: 14/599,520

(22) Filed: Jan. 18, 2015

(51) Int. Cl. A63C 3/00; F21V 23/04; F21V 5/00; F21L 4/08; F21V 33/00

(52) U.S. Cl. CPC A63C 3/00; F21L 4/08; F21V 33/0008; F21V 5/00; F21V 23/0457; F21Y 2101/02

(57) ABSTRACT

A light-emitting skate comprising a vamp, a skating assembly and a sole body, wherein the sole body further comprising a through-hole slot, a battery and a light-emitting lamp; wherein the through-hole slot is covered with a light refracting sheet; and wherein the battery is connected with the light-emitting lamp via a control circuit; wherein that the said light-emitting lamp is a self-sensing LED lamp; wherein the said the light refracting sheet is made of polycarbonate; wherein a switch groove is formed on the edge of a narrow middle portion of the sole body; and wherein a control switch of the power switch is located outside the edge of the narrow middle portion of the sole body; wherein the said battery is mounted in the battery groove via a battery case; wherein the said battery is a rechargeable battery.

### FIELD OF INVENTION

The present invention relates to a light-emitting sole and a light-emitting skate with the light-emitting sole.

### BACKGROUND

Skating has become more and more popular sport. Conventional skates have no light emitting function and have very simple appearance. The main types of skates are figure skating blades and four-roller quad skates. Such skates mainly consists of a vamp and a sole, wherein rollers or a single blade is arranged underneath the sole. The conventional skates are simple in structure and unitary in function, and thus accidents are likely to happen to skaters during skating at night or in places with dim light.

### SUMMARY OF INVENTION

To solve the technical problems of unitary function and lack of safety in the prior art, the present invention provides a light-emitting sole and a light-emitting skate with attractive appearance and high safety performance.

The present invention provides a light-emitting sole that can comprise a sole body, wherein the sole body further comprising a through-hole slot and a battery groove; a battery mounted in the battery groove; and a light-emitting lamp mounted in the through-hole slot; wherein the through-hole slot is covered with a light refracting sheet; and wherein the battery is connected with the light-emitting lamp via a control circuit, wherein the control circuit further comprising a power switch.

In one embodiment, the said light-emitting lamp can be a self-sensing LED lamp.

In another embodiment, the light refracting sheet can be made of polycarbonate, and provided with diamond patterns.

In another embodiment, there can be switch groove formed on the edge of a narrow middle portion of the sole body, and wherein a power switch can be mounted in the switch groove; and wherein a control switch of the power switch can be located outside the edge of the narrow middle portion of the sole body.

In another embodiment, the battery can be mounted in the battery groove via a battery case, and the power switch can be mounted on the battery case.

In another embodiment, the battery can be a rechargeable battery; wherein a charging jack slot can be further provided on the edge of the narrow middle portion of the sole body, and a USB charging jack can be mounted in the charging jack slot; and wherein the USB charging jack can be located outside the edge of the narrow middle portion of the sole body, and connected to the control circuit.

### BRIEF DESCRIPTION OF THE DRAWINGS

Further features and advantages of the present device, as well as the structure and operation of various embodiments of the present device, will become apparent and more readily appreciated from the following description or the preferred embodiments, taken in conjunction with the accompanying drawing of which:

FIG. 1 is an exploded view of a light-emitting skate wherein the skating assembly comprises a blade;

FIG. 2 is an exploded view of a light-emitting skate wherein the skating assembly comprises four rollers; and

FIG. 3 is an exploded view of a light-emitting skate without the skating assembly.

### DETAILED DESCRIPTION OF THE DRAWINGS

In the following detailed description, reference is made to the accompanying drawings that form a part hereof, and in which is shown by way of illustration specific implementations that may be practiced. These implementations are described in sufficient detail to enable those skilled in the art to practice the implementations, and it is to be understood that other implementations may be utilized and that logical, mechanical, electrical and other changes may be made without departing from the scope of the implementation. The following detailed description is, therefore, not to be taken in a limiting sense.

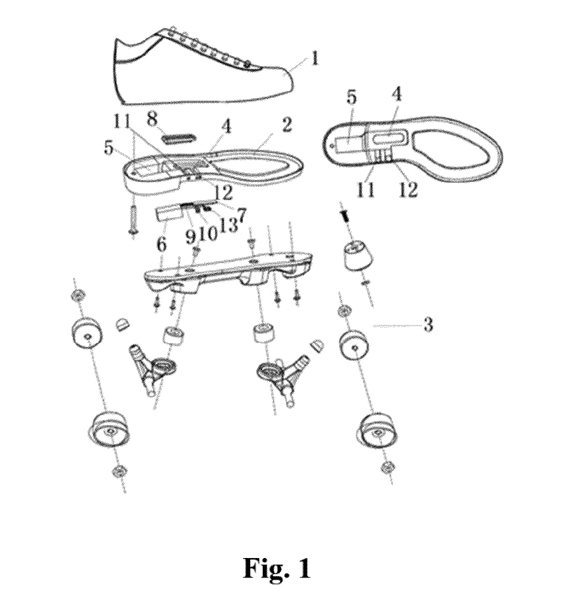

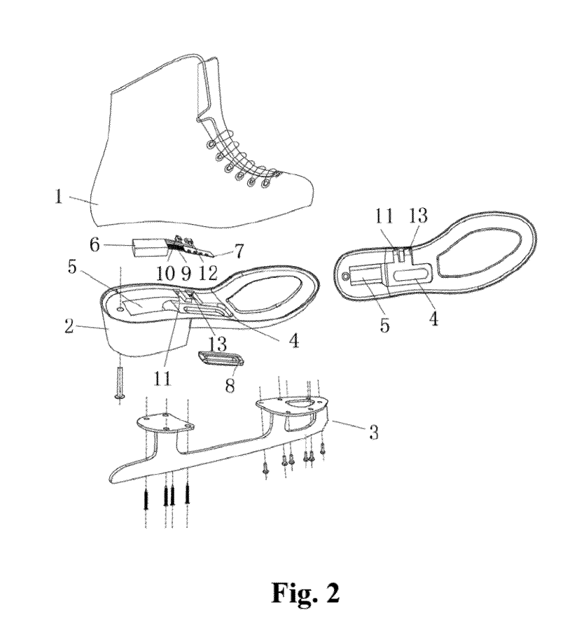

Referring to FIGS. 1 and 2, a light-emitting skate can comprise: a vamp 1, a sole body 2 and a skating assembly 3, wherein the vamp 1 is arranged above the sole body 2; wherein the skating assembly 3 is mounted to the sole body 2; the sole body 2 is provided with a through-hole slot 4 in the middle part and a battery groove 5 in the back part; a battery 6 is mounted in the battery groove 5, and a light-emitting lamp 7 is mounted in the through-hole slot 4; the through-hole slot 4 is covered with a light refracting sheet 8; and the battery 6 is connected to the light-emitting lamp 7 via a control circuit 9, which is further provided with a power switch 10; a switch groove 11 is formed on the edge of a narrow middle portion of the sole body 2, and a power switch 10 is mounted in the switch groove 11; and a control switch of the power switch 10 is located outside the edge of the narrow middle portion of the sole body 2.

The light-emitting lamp 7 is a self-sensing LED lamp, so that the LED lamp can emit light once a skater wears the skates for skating. During the skating, a person behind the skater can see the lamp light clearly at night or in a place with dim light, and the visibility makes it safer for the skater. When the skater finishes skating, the LED lamp turns off automatically to save energy and power, so that the skate is more convenient to use.

Moreover, the light refracting sheet is made of polycarbonate, and provided with diamond patterns. The light refracting sheet can refract the lamp light to make the lamp light crystal clear and more beautiful and achieve better visual effect.

Furthermore, the battery 6 is a rechargeable battery; a charging jack slot 12 is further provided on the edge of the narrow middle portion of the sole body 2, and a USB charging jack 13 is mounted in the charging jack slot 12; and the USB charging jack 13 is located outside the edge of the narrow middle portion of the sole body 2, and connected to the control circuit 9. Thus, the battery needs no replacement, and instead can be charged in time via the USB jack.

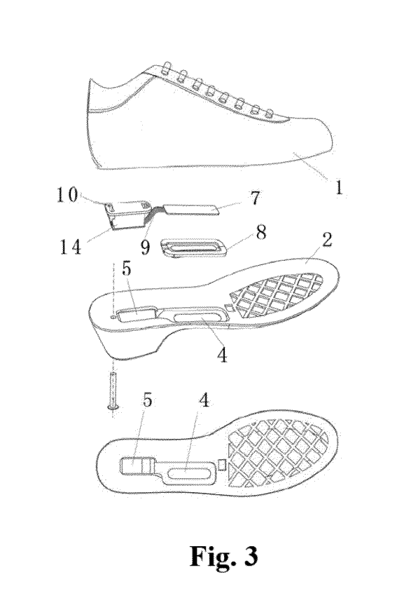

FIG. 3 shows a specific implementing structure of a light-emitting skate needing battery mounting only, specifically including: a vamp 1 and a sole body 2, wherein the vamp 1 is arranged above the sole body 2; the sole body 2 is provided with a through-hole slot 4 in the middle part and a battery groove 5 in the back part; a light-emitting lamp 7 is mounted in the through-hole slot 4; the through-hole slot 4 is covered with a light refracting sheet 8; a battery 6 is mounted in a battery case 14, and connected with the light-emitting lamp 7 via a control circuit 9; the battery case 14 is mounted in the battery groove 5; and a power switch 10 is mounted on the battery case 14. As the battery is mounted using a battery case 14, it is more convenient to mount and to remove the battery.

The light-emitting lamp 7 is a self-sensing LED lamp, so that the LED lamp can emit light once a skater wears the skates for skating. During the skating, a person behind the skater can see the lamp light clearly at night or in a place with dim light, and the visibility makes it safer for the skater. When the skater finishes skating, the LED lamp turns off automatically to save energy and power, so that the skate is more convenient to use.

Moreover, the light refracting sheet is made of polycarbonate, and provided with diamond patterns. The light refracting sheet can refract the lamp light to make the lamp light crystal clear and more beautiful and achieve better visual effect.

1. A light-emitting skate, comprising:
a sole body, wherein the sole body further comprising a through-hole slot and a battery groove;
a battery mounted in the battery groove; and
a light-emitting lamp mounted in the through-hole slot;
a skating assembly mounted on the bottom of the sole body;
a vamp mounted on top of the sole body;
wherein the through-hole slot is located in the middle part of the sole body; wherein the light-emitting lamp emits light in a direction perpendicular to the bottom of the sole body through the through-hole slot wherein the through-hole slot is covered with a light refracting sheet parallel to the bottom surface of the sole body; and wherein the battery is connected with the light-emitting lamp via a control circuit, wherein the control circuit further comprising a power switch.

2. The light-emitting skate as described in claim 1, wherein that the said light-emitting lamp is pressure sensing LED lamp.

3. The light-emitting skate as described in claim 2, wherein the said light refracting sheet is made of polycarbonate, and provided with diamond patterns.

4. The light-emitting skate as described in claim 3, wherein a switch groove is formed on the edge of a narrow middle portion of the sole body, and wherein the power switch is mounted in the switch groove; and wherein a control switch of the power switch is located outside the edge of the narrow middle portion of the sole body.

5. The light-emitting skate as described in claim 3, wherein the said battery is mounted in the battery groove via a battery case, and the power switch is mounted on the battery case.

6. The light-emitting skate as described in claim 4, wherein the battery is a rechargeable battery; wherein a charging jack slot is further provided on the edge of the narrow middle portion of the sole body, and a USB charging jack is mounted in the charging jack slot; and wherein the USB charging jack is located outside the edge of the narrow middle portion of the sole body, and connected to the control circuit.

7. A light-emitting skate comprising:
a vamp;
a skating assembly;
and a sole body;
wherein the through-hole slot is located in the middle part of the sole body; wherein the light-emitting lamp emits light in a direction perpendicular to the bottom of the sole body through the through-hole slot; wherein the sole body further comprising a through-hole slot and a battery groove; a battery mounted in the battery groove; and a light-emitting lamp mounted in the through-hole slot; wherein the through-hole slot is covered with a light refracting sheet;
wherein the battery is connected with the light-emitting lamp via a control circuit, wherein the control circuit further comprising a power switch;
wherein that the said light-emitting lamp is a self-sensing LED lamp; wherein the said light refracting sheet is made of polycarbonate, and provided with diamond patterns;
wherein a switch groove is formed on the edge of a narrow middle portion of the sole body, and wherein the power switch is mounted in the switch groove;
wherein a control switch of the power switch is located outside the edge of the narrow middle portion of the sole body;
wherein the said battery is mounted in the battery groove via a battery case, and the power switch is mounted on the battery case; and
wherein the said battery is a rechargeable battery; wherein a charging jack slot is further provided on the edge of the narrow middle portion of the sole body, and a USB charging jack is mounted in the charging jack slot; and wherein the USB charging jack is located outside the edge of the narrow middle portion of the sole body, and connected to the control circuit.
